(19) United States
(12) Patent Application Publication
(10) Pub. No.: US 2009/0100260 A1
(43) Pub. Date: Apr. 16, 2009

(54) Location source authentication

(75) Inventor: Gunasekaran Govindarajan, San Diego, CA (US)

Correspondence Address: GUNASEKARAN GOVINDARAJAN, UNIT 147, 12968 CARMEL CREEK ROAD, SAN DIEGO, CA, 92130, US

(73) Assignee: GUNASEKARAN GOVINDARAJAN

(21) Appl. No.: 12/151,476

(22) Filed: May 7, 2008

Related U.S. Application Data
(60) Provisional application No. 60/928,330, filed on May 9, 2007.

(51) Int. Cl. H04L 9/00; G08B 5/22

(52) U.S. Cl. 713/155; 340/825.36; 713/171

(57) ABSTRACT

A method and system to validate the source of the location data, such that access to location based service is protected based on a location. When the source of the location data is verified, an authentication, and/or a temporary key pair are generated for the computational device to successfully get the location based service. Moreover, the Location Based Service is assured of providing service to the computational device only at the authorized location. A method and system for managing access to the location based service is also disclosed. A request is received to authenticate the source of the location either by the computational device or by the location based service provider. Access to the location based service is granted when the location is an authorized location. Once access is granted, the temporary key pair is used for successful transactions. Moreover, the validity of the location source is constantly validated by expiring the temporary key pair with time duration.

### CROSS REFERENCE TO RELATED APPLICATION

This application claims priority of U.S. Provisional application Ser. No. 60/928,330, filed on May 9, 2007, entitled “Methods of obtaining, verifying and validating geographical location information”, the content of which is incorporated herein by reference in its entirety.

### BACKGROUND

The present invention relates to the field of Location Verification and Authentication of the source of the Location. More particularly, it relates to a method and system for verifying, authenticating and certifying geographical location, by validating and authenticating the source of the location, reported by a mobile or stationary device, based on the internal and external data related to the actual geographical location from which a request to authenticate the location is initiated.

A network is formed by connecting a plurality of computational devices. Examples of a computational device include, but are not limited to, a personal computer, a laptop, a personal digital assistant (PDA), a mobile phone and any electronic device with a micro-controller. A computational device stores data on a storage device. Examples of a storage device include, but are not limited to, a hard disk, a compact disk, a pen drive, a floppy disk, and a magnetic tape. With technological development computational devices have become capable of providing Services based on geographical locations. Examples of location services include, but are not limited to, Navigation Systems, Missile Guidance Systems, Asset Tracking Systems and Location based Authentication Systems. All these location services use GPS as one of their primary source for obtaining geographical locations. While military devices use protected and encrypted channels to restrict spoofing of the GPS data, Civilian devices are not verifying the authenticity of location information before providing the services. The location information may be crucial for applications accessing secured information. Access to some of these devices themselves restricted based on the geographical locations. Some of these data accessed based on locations could be more sensitive, such as military information, personal information, a research report and the like. Access to the devices and the data from unauthorized locations needs to be restricted. Computational device obtain its geographical location through GPS directly or indirectly and use the location information to provide services. The Service Provider needs to verify the location that the computational device provides. The computational device may be connected in a Network. The Service may be requested from other computational devices connected to the network. Examples of a network include, but are not limited to, the Internet, an Extranet, an Ethernet, a Local Area Network (LAN), a Personal Area Network (PAN), a Wide Area Network (WAN), a Campus Area Network (CAN), a Metropolitan Area Network (MAN), a Global System Mobile (GSM) network, and a Code Division Multiple Access (CDMA) network. It becomes even more important to verify the authenticity of the location data provided by the computational device on the network when the request for the service is made from different geographical locations.

There exist various methods to control the access to data stored on a computational device. U.S. Pat. No. 7,000,116, titled “Password value based on geographic location”, describes the use of distinct passwords for different geographical locations to restrict access the computational device that stores the data.

U.S. Pat. No. 5,757,916, titled “Method and apparatus for authenticating the location of remote users of networked computing systems”, describes a method and system for authenticating access to an electronic device that stores the data.

U.S. Pat. No. 7,080,402, titled “Access to applications of an electronic processing device solely based on geographic location”, illustrates the use of a username, a password and the location (latitude and longitude) based authentication to control access to various applications (computer program) that uses the data. Examples of applications can include word-processing software, email software, picture viewing software, database server, search engines and the like.

One or more of the above-mentioned methods attempt to protect the GPS data by expensive dedicated channels or through data encryptions. The dedicated channel approach will not address the need to address millions of mobile and non-mobile devices that uses GPS location information.

Further none of the above mentioned methods validate the authenticity of the location data itself. A simulated GPS data could be transmitted or fed to the GPS receiving device in a controlled and uncontrolled environment to mislead the GPS receiving device. For example, the GPS data obtained in San Francisco could be fed to a device located in San Diego. These data could be a previously captured and stored GPS data or a completely simulated data. The device not knowing the fake data, derive the location information from the GPS data fed.

Therefore, there exists a need for a method and system to restrict unauthorized access to the data stored on a computational device or restrict getting a location based service from an un-authorized location by verifying and authenticating the location claimed by the Computational Device. Further, there is a need for a method and system to restrict unauthorized access to a Computational Device itself by verifying and authenticating the location claimed by the device. Further, there exists a need for a method and system to cross verify the location information claimed by a device. Further, there exists a method and system to cross verify, authenticate GPS data claimed by a computational device.

### SUMMARY

An object of the invention is to cross check the location data provided by a device with respect to the geographical location claimed by the device and validate the source of the location.

An object of the invention is to cross check the GPS data provided by a device with respect to the geographical location claimed by the device.

Another object of the invention is to restrict access to any Location Based Services by verifying the authenticity and accuracy of the location information claimed by the device with internal or external references.

Another object of the invention is to restrict unauthorized access to a location protected device and location protected data stored on a computational device from an unauthorized location by verifying the authenticity of the location claimed and validating the source of the location.

Another object of the present invention is to restrict unauthorized access to the location based service, even if access to the computational device at which the location based service is stored, is obtained by verifying the authenticity of the location claimed.

Yet another object of the present invention is to restrict access to location based service with a previously obtained authorization.

In accordance with the above-mentioned objects, and those mentioned below, the present invention comprises a method for managing access to location based services on a first computational device. The location based services can only be obtained from an authorized location.

In accordance with the above-mentioned objects, and those mentioned below, the present invention comprises a method for configuring access to location based service on a first computational device.

In accordance with the above-mentioned objects, and those mentioned below, the present invention comprises a location based service authentication system for managing access to location protected data and or service on a computational device. The system comprises a request receiving module (RRM), a data-retrieving module (DRM), an encryption-decryption module (EDM), a query module (QM), a cross-reference module (CRM), a response sending module (RSM), a verification and authentication module (VAM), a temp key generating module (KGM) and a control module (CM). The RRM receives a request from the computational device to either verify the computational device's location as claimed or a request to a location based service. The request from the computational device contains location data. One such example is GPS data. The DRM retrieve the Data part and pass it to EDM. The CM decides whether to service the request or not, what kind of service to provide and which module should provide the service. The QM query and collect further information if required from the requesting computational device. QM also gets secondary location data from trusted, verified resources and passes that to VAM. The VAM analyze both the request and reference data and validates the location data claimed in the request data. Based on the request type the VAM just validate the location or generate a temporary key pair (KGM) that the Computational Device (requester) and a respective Location Based Service could use for a transaction. The key pair can further be tied to time duration for validity, forcing the Computational Device to revalidate the location source. A wired and/or wireless infrastructure with secured, known physical location information is used to verify the location claimed by a computational device in a mobile and/or unsecured infrastructure, thereby authorizing the source of the location provider for the computational device.

In accordance with the above-mentioned objects, and those mentioned below, the present invention comprises a method for verifying the geographical location data using reference data from known, trusted sources.

### BRIEF DESCRIPTION OF THE DRAWINGS

The preferred embodiments of the invention will hereinafter be described in conjunction with the appended drawings, provided to illustrate and not to limit the invention, wherein like designations denote like elements, and in which:

FIG. 1 illustrates an environment where various embodiments of the invention can be practiced;

FIG. 2 is a block diagram of a Geo Validation System, in accordance with an embodiment of the invention;

FIG. 3 is a flow diagram illustrating a method for managing access to location protected data on a first computational device, in accordance with an embodiment of the invention;

FIG. 4 is a flow diagram illustrating of a method for managing location verified with the Geo Verification Service and get the Location Based Service in a Computational Device;

FIG. 5 is a flow diagram illustrating a method for managing a request to validate location data and providing a transaction key to both LBS consumer and to the LBS provider, in accordance with an embodiment of the invention;

FIG. 6 is a flow diagram illustrating a process for generating temporary key pair for a successfully validated location and to a Location Based Service;

FIG. 7 is a block diagram illustrating a method of validating location source without Wireless infrastructure and using challenge protocols;

FIG. 8 is a flow diagram illustrating validation of the location source in a non-wireless infrastructure using challenge protocols;

FIG. 9 is an illustration of the embodiments on this invention used calculating the location of a computational devices;

FIG. 10 is an illustration of how signal speed and travel time from the same satellites on a given time, results in two distinct locations;

### DESCRIPTION OF PREFERRED EMBODIMENTS

The present invention provides a method and system for managing access to location based services to a computational device. When a request is made to access the location based service from a computational device the location is authorized by the Geo Verification System, thereby authorizing the source of the location provider to the computational device.

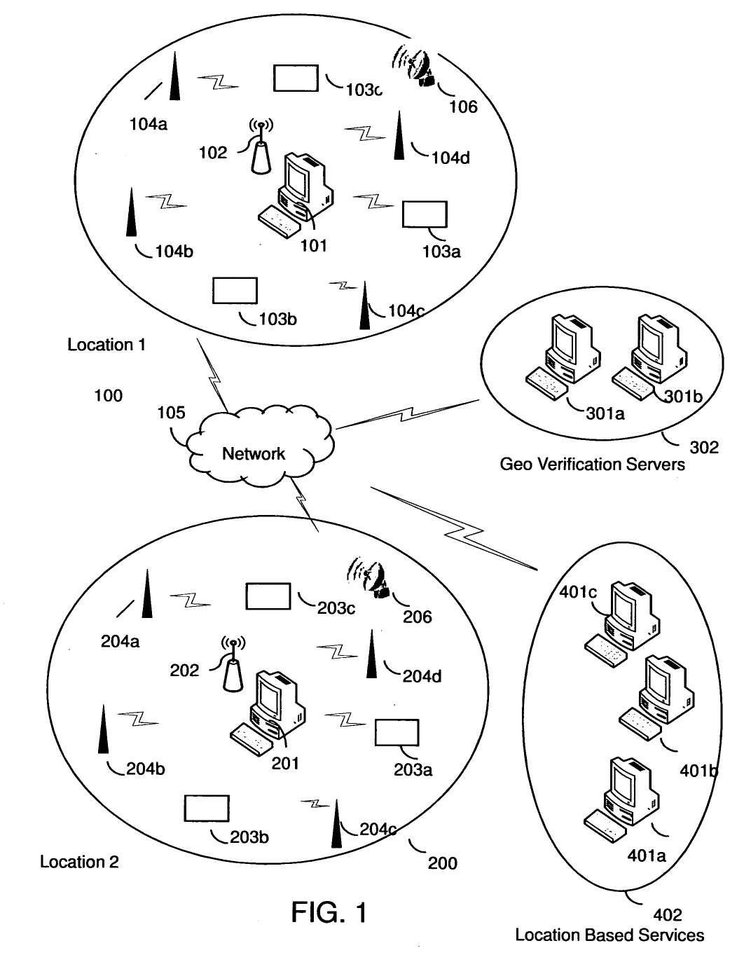

FIG. 1 illustrates an environment 100 where various embodiments of the invention can be practiced. Environment 100 includes a network 105. Examples of network 105 include, but are not limited to, the Internet, an Ethernet, a Local Area Network (LAN), a Wide Area Network (WAN), a Metropolitan Area Network (MAN), a Global System Mobile (GSM) network, and a Code Division Multiple Access (CDMA) network, Wide Area Augmentation Systems (WMS), European Geostationary Navigation Overlay Service (EGNOS), MTSAT Satellite-based Augmentation System (MSAS) and other forms of Wide Area Differential GPS (WADGPS) 106, 206. Network 105 includes a plurality of computational devices such as computational devices 101. Examples of a computational device include, but are not limited to, a personal computer, a laptop, a personal digital assistant (PDA), and a cellular phone. The primary Location Provider 102 for the Computational devices include, but not limited to, a GPS receiver, Wireless infrastructure, a location broadcaster and another computational device. Further, computational devices 101 and 201 may be located at different locations say San Francisco and San Diego, respectively.

A location provider provides location information of a user situated at a geographical location. For example, location providers 102 and 202 provide location information of computational devices 101 and 201, respectively. Examples of a location provider include, but are not limited to a Global Positioning System (GPS) enabled system, a hardware module, a software module, and a combination of a hardware module and a software module. Location information includes details such as the latitude, the longitude, the altitude and the area of the location and is transmitted through Network 105 so that the location of the person requesting the data may be ascertained. In the case of the location provider being a GPS source the Almanac and Ephemeris data, Signal strengths, date & time data are also passed to the Geo Verification System (GVS) 300.

The Geo Verification System 300 includes, but not limited to, one or more computational devices 301a, 301b, a Local Area Network (LAN), a Wide Area Network (WAN), a Metropolitan Area Network (MAN), a GSM network, a CDMA network, Wide Area Augmentation Systems (WMS), European Geostationary Navigation Overlay Service (EGNOS), MTSAT Satellite-based Augmentation System (MSAS) and other forms of Wide Area Differential GPS (WADGPS) 106, 206, Internet, Intranet and Software Programs. GVS validates the request and collects additional data from the requester 101. The additional data include, but not limited to, GPS Almanac and Ephemeris Data, Signal strengths from GPS satellites, Signal Strengths from Base Stations 103a, 103b, 103c, 103d, Signal Strengths from Cell Towers 104a, 104b, 104c, 104d and WADGPS data. GVS verifies these data from the requester against its known data references, estimates wherever a closer references were not available, The reference resources include, but not limited to, Base Stations 103a, 103b, 103c, 103d, Cell Towers 104a, 104b, 104c, 104d and other previously authenticated mobile, stationary devices like the requester 101.

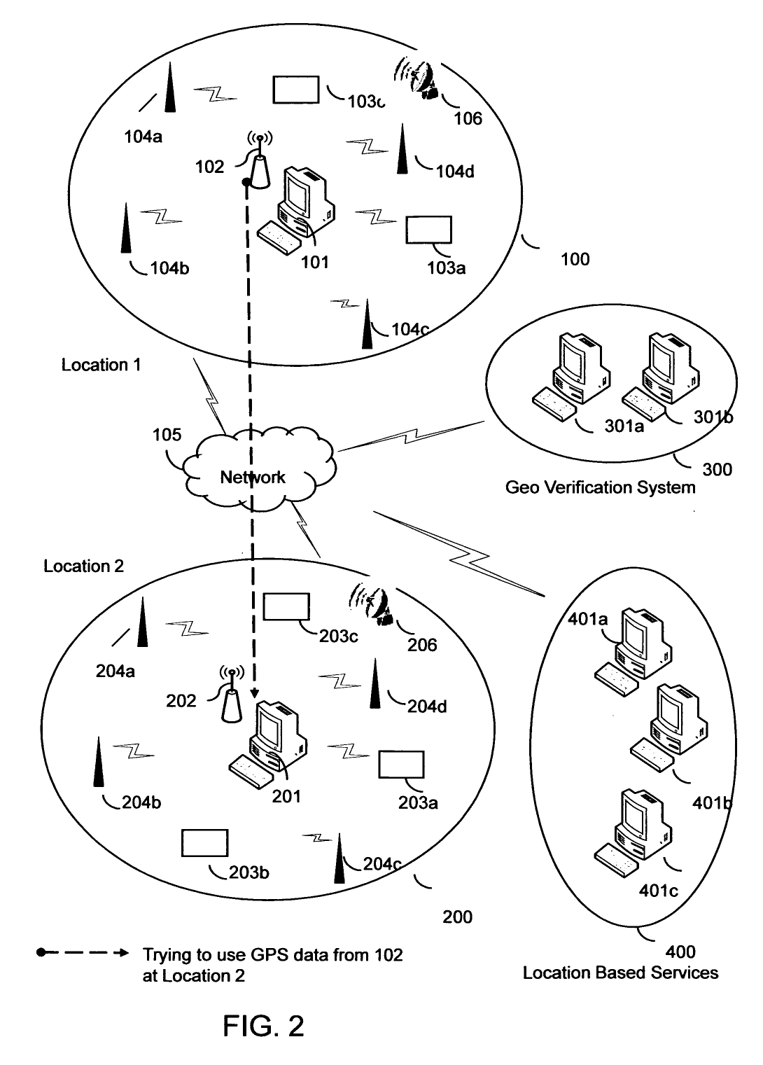

Location Based Systems 400 include, but not limited to, computational devices 401a, 401b, 401c, software programs, LAN, WAN and MAN. It should be noted that Location Based Services could reside outside computational devices as shown in FIG. 1 and FIG. 2 or could reside inside the computational devices 101, 201. They are shown out side the location 1 and location 2 just for explanation purpose.

The Almanac data is course orbital parameters for all Satellite Vehicles (SV). Each SV broadcasts Almanac data for ALL SVs periodically. The almanac data is not very precise and is considered valid for up to several months. The Ephemeris data is by comparison is very precise orbital and clock correction for each SV and is necessary for precise positioning. EACH SV broadcasts ONLY its own Ephemeris data. This data is only considered for a very short duration, typically for about 30 minutes. Ephemeris data is broadcasted by each SV approximately every 30 seconds. Sample Ephemeris data provided in Appendix A.

Locations calculated based on GPS satellite alone is not accurate due to the ionosphere, clock drifts and the orbital variations of the SVs. A constant correction is broadcasted by ground based stations directly or through WMS satellites. This Ephemeris data, orbital variation of the satellites, the variation of the ionosphere and the clock drifts, the differential corrections broadcasted by WADGPS systems are very close, at any given time for a given location. In other words the data reported by 201 and 101 are different for a given time. The Geo Verification System with its collected knowledge on these information from previously verified resources 104a, 104b, 104c, 104d, 103a, 103b, 103c, 103d, and 106 validate the requesting device's location source. For example, computational device 201 from location 2, providing location data from 102 to GVS will fail as the location data and the respective reference data from 204a, 204b, 204c, 204d, 203a, 203b, 203c, 203d and 206 are not close enough.

Once the source of the location provider 102, 202 is authenticated by the GVS 300, the authentication data is used to get Location Based Services 400. The frequency of the geo verification requirement may be configured and implemented between GVS, LBS and the Computational Devices. The origin of the request to validate the location may come directly from the computational device 101, 201 or indirectly from the LBS 400. It is only for the clarity of explanation this invention illustrate the request initiation from the computational devices.

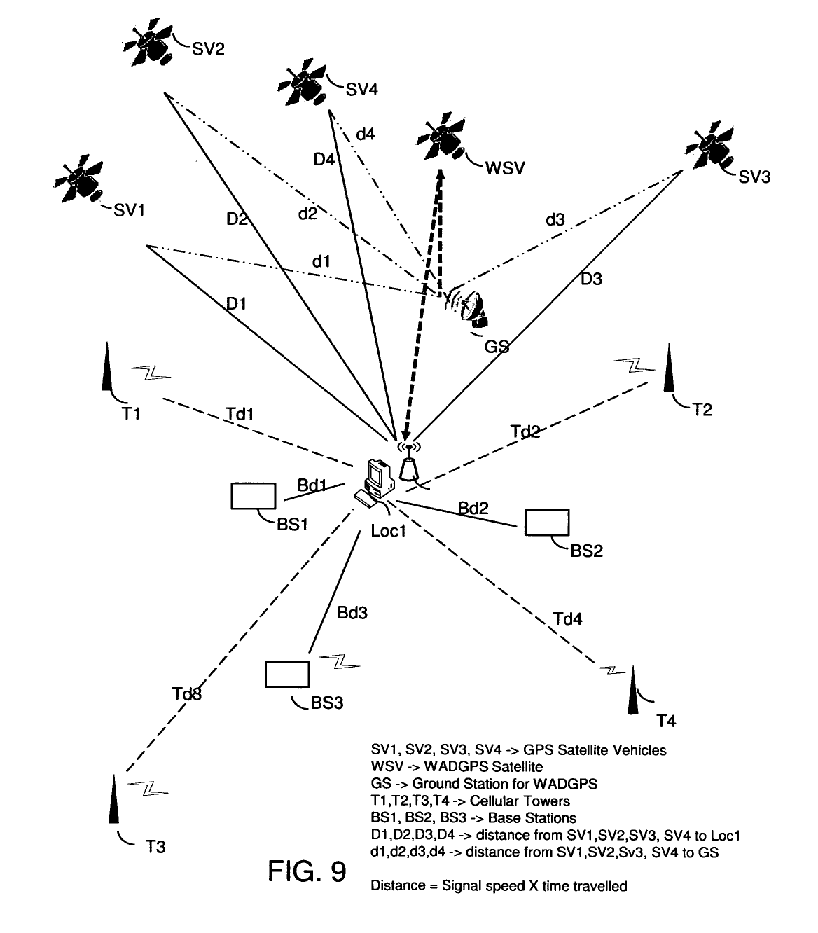

FIG. 9 is another representation of the embodiments in this inventions used to calculate the exact geographical location of the computational device. Distance traveled is calculated with Signal Speed multiplied by the Time taken to travel the distance. That is, Distance=Velocity×Time. When the satellite vehicles generate unique pseudo-random codes the GPS receiver also generate the same pseudo-random codes. With phase shift between the self generated pseudo-random code and the satellite generated pseudo-random code the GPS receiver calculates the time traveled by the signal from GPS satellite to the GPS receiver. This travel time multiplied by the speed of signal (speed of light) give the range of the GPS satellite. Because of the GPS receiver's internal clock errors caused due to non-atomic clock, to determine position using pseudo-range data, a minimum four satellites must be tracked and the four fixes must be recomputed until the clock error disappear. The geo verification system uses the same triangulation method to estimate the location of the computational device. Unless both the GPS receiver and the Wireless module that communicates with the Base Stations BS1, BS2,BS3 and the Cell towers T1, T2 and T3 the calculated location of the computational device will not match to “Loc1” calculated by GPS data. In should also be noted that only four satellite vehicles are shown to illustrate the technology, for the clarity of explanation.

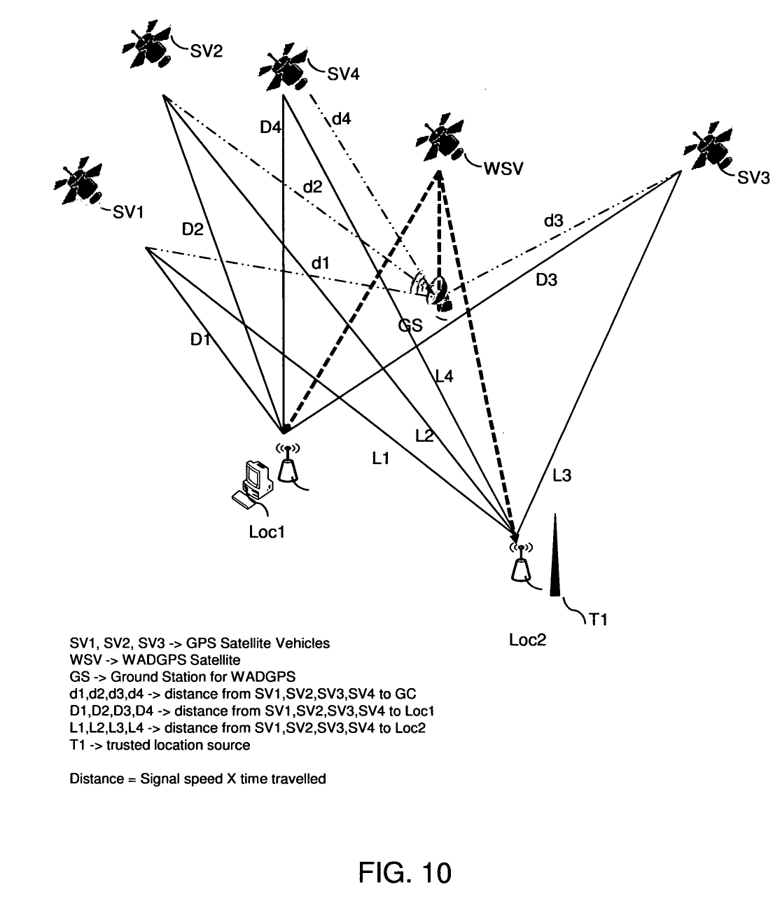

FIG. 10 illustrates how difference in distance from the same satellite vehicles result in two distinct locations “Loc1” and “Loc2”. The WADGPS system ground station “GS” calculates the delays caused due to ionosphere, change in satellite positions and broadcasts the corrections periodically either through WADGPS satellite WSV or through ground transponders.

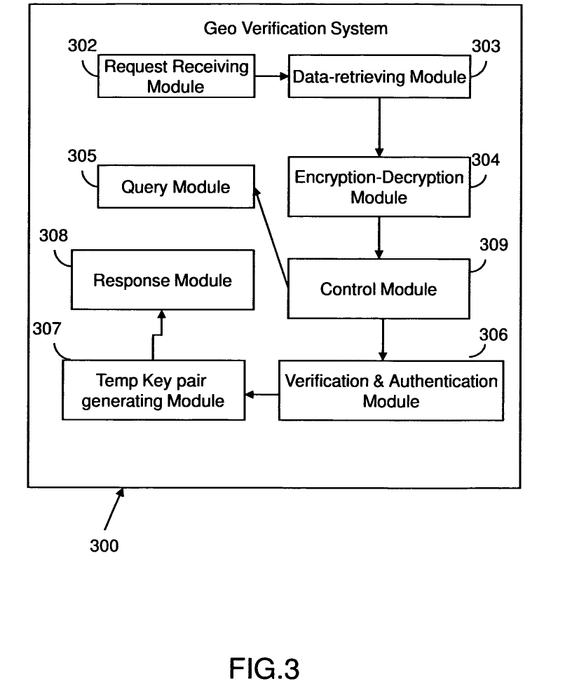

FIG. 3 is a block diagram of a Geo Verification System 300, in accordance with an embodiment of the invention.

It should be noted that the invention various modules are illustrated and described independently for the sake of clarity; however the invention can be implemented with combined modules and functionalites shared across more than one module. For example the Request Receiving Module 302 may do the functionalities of the Response Module 308.

Geo Verification System 300, includes a request receiving module 202, a request receiving Module 302, a data retrieving module 303, an encryption-decryption module 304, a query module 305, a verification and authentication module 306, a temp key paid generating module 307, a control module 309 and a response module 308. Request receiving module 302 can receive a request to authenticate location data obtained from sources like 102, 202 from the computational device 101 and 201. The data retrieving module 303 separate the payload and passes the data for decryption by the encryption-decryption module 304. The control module 309 decides to collect further data from the requester or from reference resources through query module 305. The request data and the reference data are analyzed by the verification & authentication module 306. On a valid location data, a temporary key pair is generated one for the requester 101, 201 and the second for the LBS provider 400. The response module 308 sends the authentication and the temporary key to get service from the LBS provider.

Control module 309 decides what kind of reference data required and how to collect the reference data. For example, the control module 309 may request Ephemeris data, Wireless Base Station IDs and signal strengths from the computational device 101, 102 and request the same from the knows reference stations like 103a, 103b, 103c, 103d, 104a, 104b, 104c, 104d and 106. The control module may further calculate the location data from its reference source data and validates with the verification and authentication module 306.

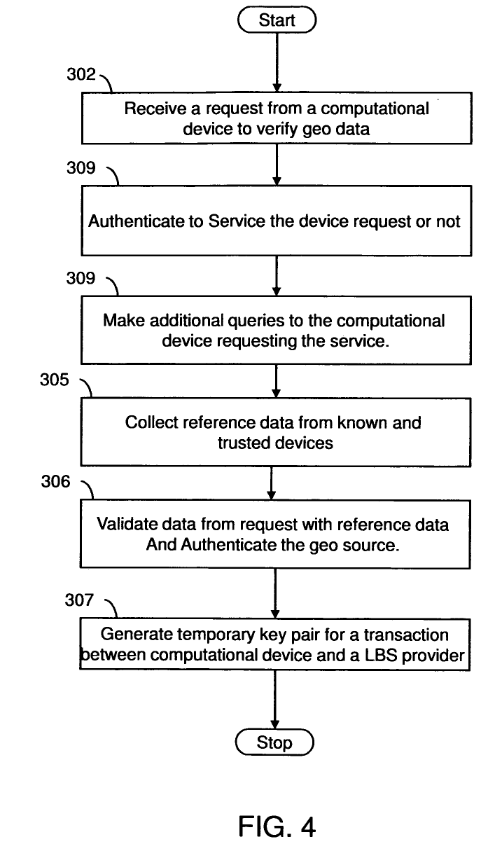

The flow of the location validation request processing is described with FIG. 4, in accordance with an embodiment of the invention.

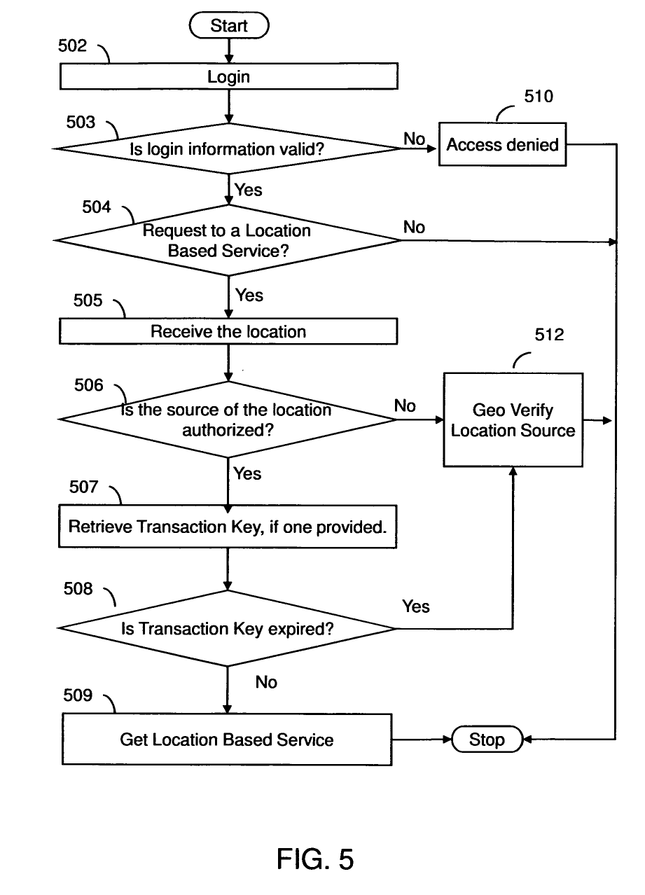

The flow of getting a Location Based Service in a computational device is described in FIG. 5, in accordance with an embodiment of the invention. For the clarity of the invention, a simple process to get a location based service is described in this FIG. 5. After a successful login 502 and 503, in a computational device, an application that may need to get a location based service receives the location data from a provider 504, in this case could be a GPS receiver. The GPS receiver acquires the GPS data from the GPS Satellites. The computational device checks whether the location provider is already authenticated by the Geo Verification System. If not, the computational device 101 sends the location data to GVS for verification and to authenticate the source of the GPS provider 512. Once the location provider authenticated the location provider, the GVS also provide a temporary transaction key 507, to the computational device to get service for a specific LBS. The GVS also sends the respective key pair to the LBS. The computational device 101, uses the temporary key to get service 509, from the LBS 400. The validity of the key may be tied to a time duration 508 as in the FIG. 5, or could simply be for a transaction.

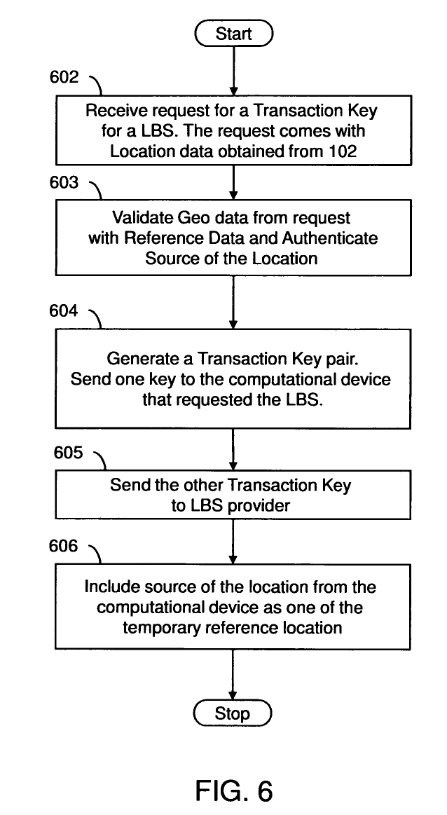

FIG. 6 flow diagram illustrates a method of generating a temporary transaction key pair at the Geo Verification System for an authenticated location provider, in accordance with an embodiment of the invention. When a request to authenticate a location provider received 602, the Geo Verification System validates the data provided and either authenticates 603 the location provider or fail to authenticate the source of the location provider based on the collected static and dynamic reference data and calculated location estimations. If the provider of the location is authenticated, in step 604, the GVS generates a dynamic key pair for the safe communications between the Computational Device 101 and the LBS 400. In step 605, GVS sends one key to the Computational Device 101 and the other key to the LBS. Further in step 606, the GVS adds, the newly authenticated provider of the location 102, to its reference data.

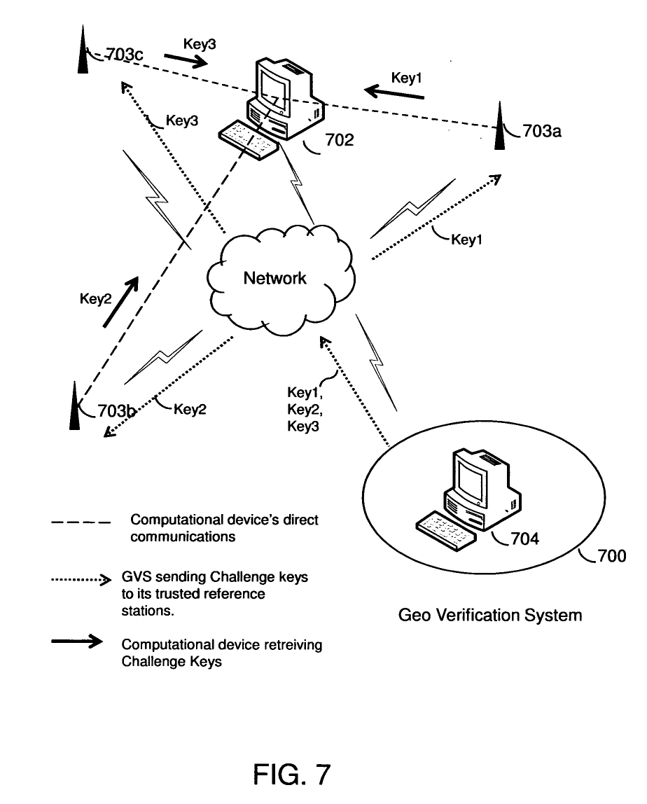

FIG. 7 illustrates an embodiment of the invention where the source of location data may not involve any GPS systems. Even the communication between the location providers 703a, 703b, 703c and the computational device 702 may be not involve any wireless transmission. In accordance with the invention a variation of the embodiment may not use a wireless modem at the computational device 102 for the communication between the computational device and the Geo Verification System 700. In this case the geo verification system uses a password challenge method validate the source of the location. When a computational device 702 claim a location by simple triangulation of 703a, 703b and 703c, now the source of the location is not a single system or device. Geo verification system in this case collects data from 703a, 703b, 703 and 702 directly and calculates the actual location of the computational device 702. During this process geo verification system may challenge computational device 702 to obtain a valid key that geo verification system just passed to one or more of these trusted reference stations 703a, 703b and 703c. Unless the computational device was in fact communicating with 703a, 703b and 703c, the computational device will fail to get the challenged key. It should be noted that the simple triangulation method of calculating the location of the computational device is described for clarity of the invention. Challenge key exchange through non-wireless method is also described for clarity of the invention. Other systems, for example a WADGPS could be used through challenges through special channels.

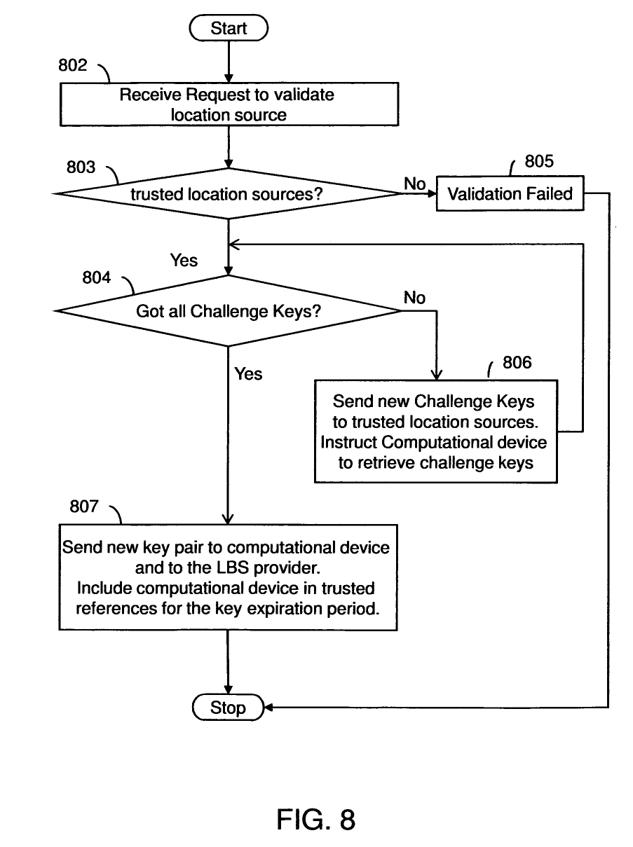

FIG. 8 is a flow chart describing an embodiment of this invention where password challenge protocol is used to validate the source location. In step 802, the geo verification system receives the request to validate the location source. In step 803, the control module checks whether the location sources reported by the computational device are trusted resources. If they are not, then in step 805, the validation request is rejected. In step 804, control module checks whether it got all the challenge keys. If not, in step 806, the control module sends the newly generated challenge keys to the trusted location sources through trusted network. More over in step 806, GVS challenges Computational device to obtain the keys sent to the location sources. In step 807, up on obtaining all challenge keys, the GVS validates the location source, generate key pairs to access location based services. More over, in step 806, GVS includes the newly validated computational device in to its trusted location sources for the duration of the access key expiration period.

In an embodiment of the invention the temporary key pairs generated at the GVS are changed by using various randomization techniques known in the art. This ensures that the previously used key pairs are not reused to access the location based services from an authorized and/or unauthorized location. The location based service includes, but not limited to access to data that may include financial data, client data, employee data, research data, military information and the like.

In an embodiment of the invention, the LBS 400 periodically obtain authenticated location providers 102, 202 from GVS 300.

The method and system of the present invention or any of its components may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer also comprises a microprocessor, which is connected to a communication bus. The computer also includes a memory, which may include Random Access Memory (RAM) and Read Only Memory (ROM). Further, the computer system is connected to a storage device, which can be a hard disk or a removable storage such as a floppy disk, optical disk, a flash card, a magnetic tape, etc. The storage device can also be other similar means for loading computer programs or other instructions into the computer system. The storage device can either be directly or remotely connected to the computer system. The computer system also includes a communication unit, which allows the computer to connect to other databases and the Internet through an I/O interface. The communication unit allows the transfer and reception of data from other databases. The communication unit may include a modem, an Ethernet card, or any similar device that enables the computer system to connect to databases and networks such as LAN, MAN, WAN, WADGPS and the Internet. The computer system facilitates inputs from a user through an input device that is accessible to the system through an I/O interface.

The computer system executes a set of instructions that are stored in one or more storage elements, to process input data. The storage elements may hold data or other information, as desired, and may also be in the form of an information source or a physical memory element present in the processing machine.

The set of instructions may include various commands that instruct the processing machine to perform specific tasks such as the steps that constitute the method of the present invention. The set of instructions may be in the form of a software program. Further, the software may be in the form of a collection of separate programs, a program module with a larger program, or a portion of a program module, as in the present invention. The software may also include modular programming in the form of object-oriented programming. Processing of input data by the processing machine may be in response to user commands, the result of previous processing, or a request made by another processing machine.

The method and system provided in the present invention restricts obtaining location based services using fake, simulated, incorrect or compromised location data. Further, the method and system restricts reusing previously authorized location data to get location based services.

While the preferred embodiments of the invention have been illustrated and described, it will be clear that the invention is not limited to these embodiments only. Numerous modifications, changes, variations, substitutions and equivalents will be apparent to those skilled in the art, without departing from the spirit and scope of the invention, as described in the claims. One simple example could be a WiFi or WiMax network in place of wireless modem and cellular network to accomplice the same.

What is claimed is:

1. A method for validating the source of the location used by a computational device, the method comprising the steps of:
a) receiving a request to authenticate and validate the source of the location data, the request being received from a computational device;
b) collecting additional location data from the computational device and the location provider;
c) collecting reference location data from trusted and previously authenticated location sources;
d) collecting signal strengths and time sensitive data from computational device, location source and the reference stations;
e) estimating the location of the location source for computational device by cross referring with trusted resources and programmatic calculations;
f) authorizing the source of the location to the computational device to get any location based service; and
g) preventing the unauthorized location based services to location compromised computational devices.

2. The method according to claim 1 further comprising the step of managing trusted location sources by adding newly authenticated location sources.

3. The method according to claim 1, wherein the location of the computational device is retrieved by using a Global Positioning System (GPS).

4. The method according to claim 1 further comprising the step of re-retrieving the location of the reference stations by using a Global Position System (GPS).

5. The method according to claim 1, wherein the location data provided by the computational device is verified against the location data obtained from the reference stations.

6. A method according to claim 1, for generating temporary key pairs for a computational device to against a validated location source to obtain location based services.

7. A geo verification system for validating and authenticating the source of the location data for a first computational device, the system comprising:
a) a request receiving module, the request receiving module receiving a request from a computational device to validate the source of the location data;
b) a data retrieving module, the data-retrieving module retrieving the payload of the request;
c) an encryption-decryption module, the encryption-decryption module decrypting and encrypting the payload of the request and response respectively;
d) a control module, the control module enabling reference data collection, location validation, and key pair generation;
e) a query module, the query module communicates with computational device and reference stations to collect data;
f) a key-pair generating module, the key-pair generating module randomly creates key pairs for authenticated location sources and the location based service for a particular instance of the location based service; and
g) means for preventing location based service from an unauthorized location by a computational device.

8. The system according to claim 7, wherein the computational device and the source of location data are the same.

9. The system according to claim 7, wherein the Wireless module and the source of location data are the same.

10. The geo verification system according to claim 7, wherein the control module and the query module collects location data from the source of the location.

11. The geo verification system according to claim 7, wherein the control module and the query module collects location data from trusted reference stations and systems.

12. The geo verification system according to claim 7, wherein the encryption-decryption module further encrypts the data between computational device, location based service provider and the geo verification system for data security.

13. The geo verification system according to claim 7, wherein the control module further estimates the location of the source by cross referencing and calculating with reference data.

14. The geo verification system according to claim 7, wherein the verification and authentication module further checks whether the source of the location for the computational device is valid or not.

15. The geo verification system according to claim 7, wherein the Temp Key pair generating module further generates at least one authorized location key corresponding to at least one authorized location.

16. The geo verification system according to claim 7, wherein the control system uses challenge protocols to obtain valid keys passed to trusted reference systems.

17. A computer program product for use with a computer stored program, the computer program product comprising a computer readable medium having a computer readable program code embodied therein for validating source of the location from a computational device or from a location based service provider, the computer readable program code including instructions for:
a) receiving a request to validate the source of the location from a computational device or from a location based service provider;
b) retrieving data from the request by decrypting and sending data encrypting;
c) collecting location data from source of the location;
d) collecting location data from the trusted reference stations; and
e) validating the source of the location and preventing access from unauthorized locations to location based service.

18. The computer program code according to claim 17, wherein the program code manages creating temporary key pair for the computational device against a location source, provided by the computational device.
